(19) United States
(12) Patent Application Publication
(10) Pub. No.: US 2019/0004885 A1
(43) Pub. Date: Jan. 3, 2019

(54) METHOD AND SYSTEM FOR AIDING MAINTENANCE AND OPTIMIZATION OF A SUPERCOMPUTER

(71) Applicant: BULL SAS, LES CLAYES SOUS BOIS (FR)

(72) Inventors: Benoit PELLETIER, ST ETIENNE DE CROSSEY (FR); Jullian BELLINO, PARIS (FR)

(21) Appl. No.: 15/737,810

(22) PCT Filed: Nov. 24, 2016
(86) PCT No.: PCT/EP2016/078714

§ 371 Date: Mar. 17, 2018

(30) Foreign Application Priority Data
Nov. 27, 2015 (FR) 1561465

(51) Int. Cl. G06F 11/07; G06F 11/34; G06F 11/30

(52) U.S. Cl. CPC G06F 11/079; G06F 11/3024; G06F 11/3452; G06F 11/0721

(57) ABSTRACT

The invention relates to a method for aiding maintenance and optimization of a supercomputer which comprises the dispatching to a system for aiding maintenance by at least one sensor of a signal representative of statistical data of at least one calculation node of the supercomputer, prediction at regular intervals of the future variations of the statistical data on the basis of signals representative of the statistical data, dispatched by the sensor or sensors, the detection of anomalies of variations of the signals representative of the statistical data, dispatched by the sensor or sensors, with respect to the future variations predicted in the prediction step. The invention also relates to a system for aiding maintenance and optimization.

### TECHNICAL FIELD OF THE INVENTION

The present invention relates to the field of supercomputers. The present invention proposes more particularly a method and a system for aiding maintenance and optimization of a supercomputer for detecting anomalies in real time for optimizing the operation of the supercomputer.

### TECHNOLOGICAL BACKGROUND OF THE INVENTION

Companies often resort to supercomputers to resolve complex problems. They in fact look for the possibility of making calculations effectively to respond to their need. This requires considerable infrastructure. Supercomputer sometimes comprise several thousand machines to supply the preferred calculating power. For example, the supercomputer TERA100 has over 3000 compute nodes. Also, all these machines are interconnected, making the infrastructure even more complex. These links are all the greater since this is a high-rate network used specifically in high-performance computing (HPC).

Aside from the fact that these supercomputers process complex problems, it is often about critical tasks. This is why, in addition to considering the performance of the supercomputer, it is also important to improve the reliability of the latter. In fact, today it can be said that a critical error appears via this type of infrastructure every half hour. In addition to these potential breakdowns, the routing which is the path by which the network packets are sent from one machine to the other must be updated constantly. In fact, according to the applications launched via the supercomputer congestion phenomena can appear.

Due to this complexity as described, human analysis is impossible or at least highly limited. In fact, the reactivity time following an error is often too long in this type of critical system, and therefore causes an interruption to services. The idea therefore is to provide a tool for aiding maintenance of the network in real time to improve this reactivity and thus minimize service interruptions. The aim is to improve the reliability of the supercomputer. Improving reliability of the supercomputer also means optimizing its use and thus the performance of calculations performed.

Document US 2014/0358833 A1 discloses a process for maintenance of a processing environment and more precisely a prediction method for predicting abnormal state of said environment at a future moment, said method consisting of obtaining one or more values of one or more of the parameters of the processing system to determine, for one or more measures, one or more values predicted for one or more points in time in the future to determine on the basis of the predicted values, one or more values of change for one or more points in time, and on the basis of one or more values of change to determine if an abnormal state exists in the processing system.

But the large number of parameters or data to be processed can burden the detection process of anomalies. Also, the method disclosed in US 2014/0358833 A1 considers some arbitrary parameters which can result in false predictions or detections of anomalies.

### GENERAL DESCRIPTION OF THE INVENTION

The aim of the present invention therefore is to eliminate one or more of the drawbacks of the prior art by proposing a method and a system for aiding maintenance and optimization of a supercomputer. This method and this system improve the reliability of the supercomputer. Improving the reliability of the supercomputer also means optimizing its use and the performance of calculations performed.

For this reason, the invention relates to a method for aiding maintenance and optimization of a supercomputer, comprising a:
sending step, by at least one sensor, of a signal representative of statistical data of at least one compute node of the supercomputer to a system for aiding maintenance;
prediction step at regular intervals, by a prediction algorithm managed by a processor of the system for aiding maintenance, of the future variations in the statistical data from the signals representative of the statistical data sent by the sensor(s) and stored in storage means of the system for aiding maintenance;
detection step in real time, by a detection algorithm managed by the processor, of anomalies of variations in the signals representative of the statistical data sent by the sensor(s) relative to the future variations predicted in the prediction step;
   said method being characterized in that the prediction steps of future variations and detection of anomalies comprise at least one first and one second filtering of said signals representative of the statistical data as a function of said sensor(s) having sent said signals necessary for implementing maintenance and optimization of said supercomputer.

According to another feature, the prediction step comprises the following steps:
storing in the storage means the statistical data sent by the sensor(s) in the form of signals representative of these statistical data;
constructing, by a modelling algorithm managed by the processor, a predictive mathematical model from the statistical data, the model being stored in the storage means;
calculating, by a calculation algorithm managed by the processor, the future variations in the statistical data from the predictive mathematical model as well as the confidence intervals delimiting the future variations in the statistical data;
storing in the storage means the future variations and the confidence intervals.

According to another particular feature, construction of the predictive mathematical model is calculated by the modelling algorithm managed by the processor from the statistical data from signals representative of these statistical data sent by the sensor(s) from the last two hours.

According to another particular feature, the prediction step is implemented at regular intervals of sixty minutes.

According to another particular feature, the detection step comprises the following steps:
comparing, by the detection algorithm managed by the processor, the signals representative of the statistical data with the future variations and confidence intervals stored last in the storage means;
storing, in the storage means, in a table of anomalies, the anomalies detected by the detection algorithm, an anomaly being detected when the signals representative of the statistical data exit from the confidence intervals and/or move away from the future variations.

According to another particular feature, the prediction step further comprises a first aggregation step, during a set time interval, by an aggregation algorithm managed by the processor, of the statistical data stored in the storage means, the detection step further comprising a second aggregation step by the processor, during the same time interval, of signals, representative of the statistical data, sent in real time by the sensor(s).

According to another particular feature, the first filtering, by a filtering algorithm managed by said processor, of the statistical data as a function of said sensor(s) having sent said signals representative of these statistical data during the prediction step, precedes the construction step, the second filtering in the detection step, by the filtering algorithm managed by the processor, of the signals representative of the statistical data coming from said sensor(s) having sent these representative signals, precedes the comparison step.

According to another particular feature, the filtering steps filter the sensors to keep only the sensors which send signals necessary for prediction and/or detection of anomalies.

According to another particular feature, the prediction step comprises a first display step in which the processor of the system for aiding maintenance sends signals representative of the values of the future variations as well as the confidence intervals to display means to be displayed by the display means.

According to another particular feature, the detection step comprises a second display step in which the processor of the system for aiding maintenance sends to the display means a signal representative of an anomaly detected by the detection algorithm when an anomaly has been detected by the detection algorithm.

According to another particular feature, the prediction step is further performed from information relating to the supercomputer, the data, stored in a storage area of said supercomputer and containing said information, being sent to the system for aiding maintenance.

The invention also relates to a system for aiding maintenance and optimization of a supercomputer including a computer infrastructure comprising at least one processor and storage means of the signals representative of the statistical data sent by at least one sensor located in at least one compute node of said supercomputer, said storage means also containing at least:
a prediction algorithm whereof execution on said processor predicts, at regular intervals, future variations in the statistical data from the signals representative of statistical data from said sensors,
a detection algorithm whereof execution on said processor detects, in real time, anomalies of variations in the signals representative of the statistical data from said sensors relative to the variations predicted by the prediction algorithm,
   said system being characterized in that it also comprises at least one algorithm whereof execution on the processor filters said signals representative of the statistical data as a function of said sensor(s) having sent said signals representative of these statistical data necessary for implementing the method of maintenance and optimization.

According to another particular feature, the computer infrastructure further comprises:
a modelling algorithm stored in the storage means capable of constructing a predictive mathematical model from the statistical data stored in the storage means,
a calculation algorithm stored in the storage means capable of calculating future variations in the statistical data from the predictive mathematical model as well as confidence intervals delimiting the future variations in the statistical data.

According to another particular feature, the detection algorithm is capable of comparing signals representative of the statistical data with the future variations and confidence intervals stored last in the storage means.

According to another particular feature, the computer infrastructure comprises at least one aggregation algorithm stored in the storage means capable of aggregating each minute of the statistical data stored in the storage means and aggregating each minute of the signals, representative of the statistical data, sent in real time by the sensor(s).

According to another particular feature, the computer infrastructure further comprises a filtering algorithm stored in the storage means capable of filtering the statistical data stored, the storage means and the signals, representative of the statistical data, as a function of the sensor(s) having sent the signals representative of these statistical data.

According to another particular feature, the computer infrastructure comprises an interface which selects for each sensor the type of signal necessary for the prediction and/or detection of anomalies and selects in all the sensors a certain number of sensors which are used for the filtering of said data or said signals necessary for the prediction and/or detection of anomalies.

According to another particular feature, the system further comprises display means capable of displaying at least the values of the future variations as well as the confidence intervals.

### DESCRIPTION OF THE ILLUSTRATIVE FIGURES

Other particular features and advantages of the present invention will become apparent from reading the following description hereinbelow given in reference to the appended drawings, in which:

FIG. 1 schematically illustrates the system for aiding maintenance and optimization according to an embodiment for a supercomputer;

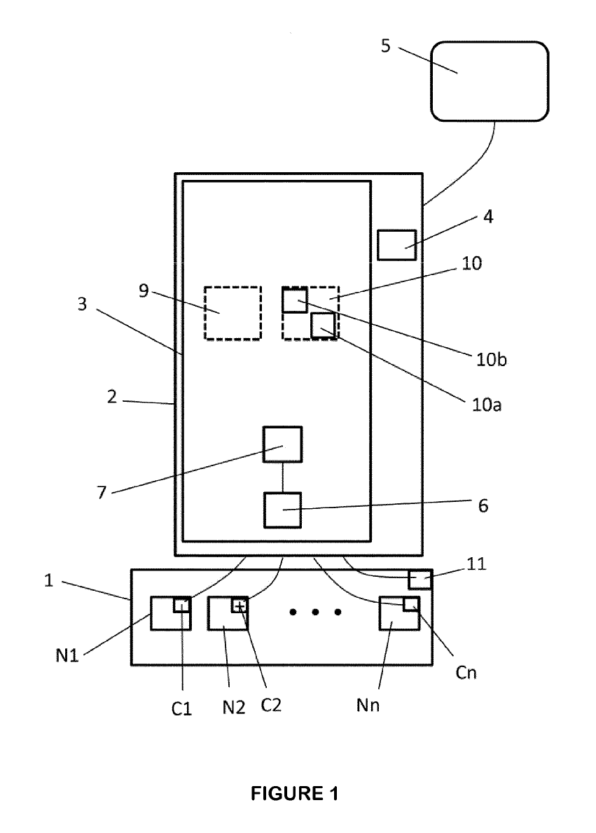

FIG. 2 illustrates a flow chart according to an embodiment of the method;

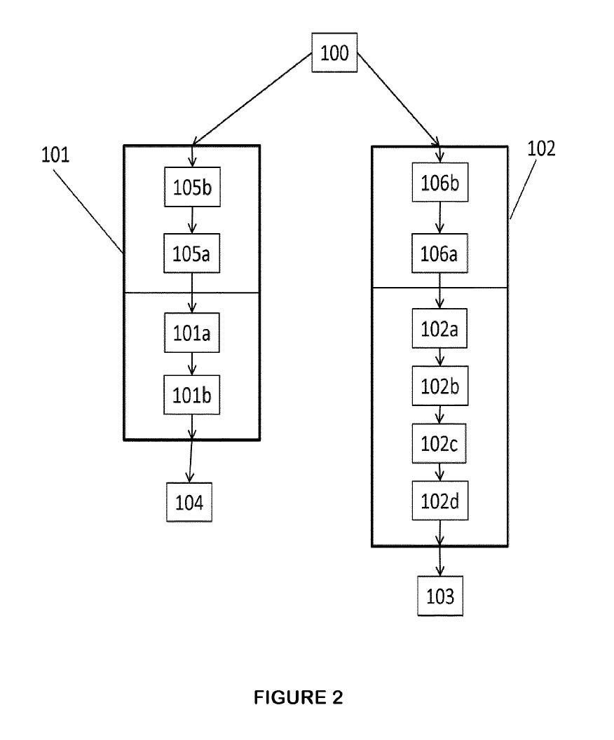

FIG. 3 schematically illustrates an example of architecture of the system for aiding maintenance and optimization;

FIG. 4 schematically illustrates a summarized flow chart of the method.

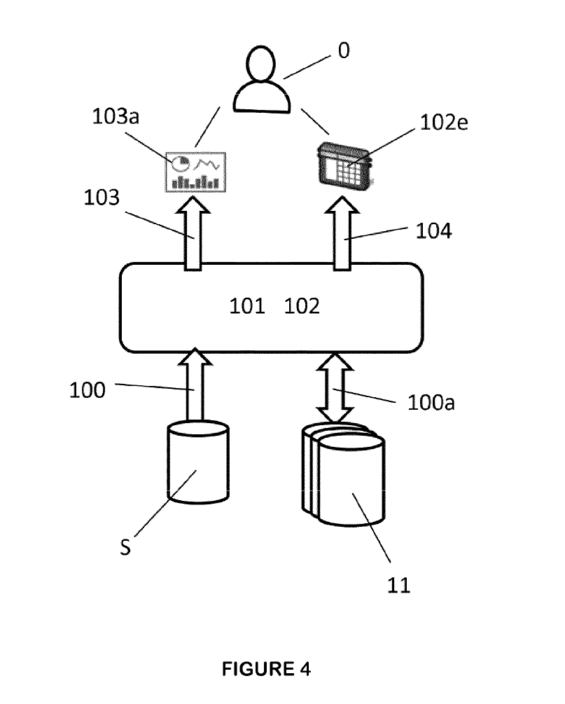

### DESCRIPTION OF THE PREFERRED EMBODIMENTS OF THE INVENTION

The invention is described hereinbelow in reference to the figures specified hereinabove.

The invention relates to a method and a system for aiding maintenance and optimization of a supercomputer (1).

The method and the system are based on a set of physical sensors (C1, C2, . . . , Cn) present, for example, on the network cards of each node (N1, N2, . . . , Nn) of a supercomputer (1). These sensors (C1, C2, . . . , Cn) can generate signals (S) representative of several statistical data.

The statistical data can be, for example, the number of packets sent by a compute node (N1, N2, . . . , Nn), the number of packets received by a compute node (N1, N2, . . . , Nn) or the number of packets lost by a compute node (N1, N2, . . . , Nn). The statistical data can be also error codes found in a compute node (N1, N2, . . . , Nn) or congestion indicators of a compute node (N1, N2, . . . , Nn).

The method and the system are also based on specific databases already present in a supercomputer (1). This database can contain statistically information relating to the supercomputer (1). For example, this database contains physical and logical information of each node (N1, N2, . . . , Nn) and their links. The database and the information are stored, for example, in a storage area of the supercomputer.

The system for aiding maintenance and optimization of a supercomputer (1) comprises a virtual or real computer infrastructure (2) hosting the business logic of the system.

The computer structure comprises at least one processor (4) and storage means (3).

The storage means (3) store at least one prediction algorithm (10) for predicting at regular intervals future variations in the statistical data from signals representative of the statistical data sent by the sensor(s) (C1, C2, . . . , Cn) and stored in the storage means (3).

The storage means (3) also comprise a detection algorithm (9) for detecting in real time anomalies of variations in the signals representative of the statistical data sent by the sensor(s) (C1, C2, . . . , Cn) relative to the variations predicted by the prediction algorithm (10).

According to an embodiment, the detection algorithm (9) can compare signals representative of the statistical data to future variations and confidence intervals stored last in the storage means (3). In a non-limiting way, the confidence interval can be fixed at 5%.

The computer infrastructure (2) can further comprise a modelling algorithm (10a) stored in the storage means (3). The modelling algorithm (10a) constructs a predictive mathematical model from the statistical data stored in the storage means (3).

According to an embodiment, the modelling algorithm (10a) constructs a model which determines each value of a temporal series as a function of the preceding values. For example, the model is a mixed auto-regressive integrated moving average (ARIMA) model. The model is stored in the storage means.

The computer infrastructure (2) can further comprise a calculation algorithm (10b) stored in the storage means (3). The calculation algorithm (10b) calculates, from the predictive mathematical model constructed by the modelling algorithm (10a), future variations in the statistical data as well as confidence intervals delimiting future variations in the statistical data.

The computer infrastructure (2) can further comprise at least one aggregation algorithm (7) stored in the storage means (3) which aggregates each minute of the statistical data stored in the storage means (3). The aggregation algorithm (7) also aggregates each minute of the signals representative of the statistical data sent in real time by the sensor(s) (C1, C2, . . . , Cn).

The aggregation algorithm (7) is for example a function which determines the average or median of a set of values. Other aggregation functions adapted to statistical data to be studies can be used.

In this way, the aggregation algorithm (7) can aggregate each minute of the statistical data by determining each minute the average or the median of the statistical data stored in the storage means (3). The aggregation algorithm (7) can also aggregate each minute of the signals representative of the statistical data in real time by determining each minute the average or the median of signals representative of the statistical data sent in real time by the sensor(s) (C1, C2, . . . , Cn).

The computer infrastructure (2) can further comprise a filtering algorithm (6) stored in the storage means (3) which filters the statistical data stored in the storage means (3) and the signals representative of the statistical data as a function of the sensor(s) (C1, C2, . . . , Cn) having sent the signals representative of these statistical data.

The system further comprises display means (5) which display values of the future variations as well as the confidence intervals. Signals representative of the values of the future variations and confidence intervals are sent by the processor (4) of the computer infrastructure (2) so that the display means (5) display these values.

The processor (4) can also send signals representative of anomalies for example in the form of a table (102e) of anomalies.

The processor (4) can also send signals representative of the statistical data in real time to the display means (5) so that these display means (5) display these values of the statistical data.

The method implemented by the system for aiding maintenance and optimization of a supercomputer (1) comprises at least one step (100) for sending, to the processor of the system for aiding maintenance by at least one sensor (C1, C2, . . . , Cn), a signal representative of the statistical data of at least one compute node (N1, N2, . . . , Nn) of the supercomputer (1). In a non-limiting way, the statistical data sent can be sent at a speed of 150 Go/h.

According to an embodiment, the sending step (100) can comprise a sending step (100a), via the databases of the supercomputer, of information relating to the supercomputer to the processor of the system for aiding maintenance and/or a consultation step (100a) of databases of the supercomputer by the processor of the system for aiding maintenance for retrieving information relating to the supercomputer.

The method further comprises a prediction step (102) at regular intervals of the future variations in the statistical data from signals representative of the statistical data sent by the sensor(s) (C1, C2, . . . , Cn) and stored in the storage means (3) of the system for aiding maintenance. The prediction step (102) is implemented by the prediction algorithm (10) managed by a processor (4) of the system for aiding maintenance.

According to an embodiment, the prediction step (102) is implemented at regular intervals of sixty minutes.

The method further comprises a detection step (101) in real time of anomalies of variations in the signals representative of the statistical data sent by the sensor(s) (C1, C2, . . . , Cn) relative to the future variations predicted in the prediction step. The prediction step is implemented by the detection algorithm (9) managed by the processor (4).

According to an embodiment, the detection step can further comprise a correlation step of signals representative of the statistical data, sent by the sensor(s) and/or consulted by the processor, with the information stored in the storage area of the supercomputer.

The prediction step (102) can comprise a storage step (102a) in the storage means (3) of the statistical data sent by the sensor(s) (C1, C2, . . . , Cn). The statistical data are sent by the sensor(s) (C1, C2, . . . , Cn) in the form of signals representative of these statistical data.

The prediction step (102) can further comprise a construction step (102b), by the modelling algorithm managed by the processor (4), of a predictive mathematical model from the statistical data stored in the storage means (3).

According to an embodiment, the construction (102b) of the predictive mathematical model is calculated by the modelling algorithm (10a) from the statistical data from the signals representative of these statistical data sent by the sensor(s) (C1, C2, . . . , Cn) from the last two hours.

The prediction step (102) can further comprises a calculation step (102c), by the calculation algorithm managed by the processor (4), of the future variations in the statistical data from the predictive mathematical model as well as confidence intervals delimiting future variations in the statistical data.

The prediction step (102) can further comprise a storage step (102d) in the storage means (3) the future variations and the confidence intervals calculated in the calculation step.

The detection step (101) can comprise a comparison step (101a), by the detection algorithm (9) managed by the processor (4), of the signals representative of the statistical data with the future variations and confidence intervals stored last in the storage means (3).

The detection step (101) can further comprise a storage step (101b), in the storage means (3), in a table (102e) of anomalies of those anomalies detected by the detection algorithm (9). An anomaly is detected when the signals representative of the statistical data exit from the confidence intervals and/or move away from the future variations.

To increase the performance of the construction step (102b) of the predictive mathematical model and limit the variations, for example sinusoidal, of signals sent by the sensors (C1, C2, . . . , Cn), the prediction step (102) further comprises a first aggregation step (106a), during a set time interval, by an aggregation algorithm (7) managed by the processor (4), of the statistical data stored in the storage means (3). Similarly, the detection step further comprises a second aggregation step (105a) by the processor (4), during the same time interval, of the signals representative of the statistical data sent in real time by the sensor(s) (C1, C2, . . . , Cn).

In a non-limiting way, the time interval is equal to 1 min.

The second aggregation step (105a) can compare the real values from the signals representative of the statistical data sent in real time to the aggregated predictive values during the prediction step at the first aggregation step (106a).

The method can comprise filtering steps (105b, 106b). These filtering steps (105b, 106b) retain only those signals necessary for prediction and/or detection of anomalies which are sent by the sensor(s) (C1, C2, . . . , Cn). For example, for a sensor, the filtering step filters the different signals sent by the sensor (C1, C2, . . . , Cn) according to the datum or the data represented by the signal(s) necessary for prediction and/or detection. Via another example, for several sensors (C1, C2, . . . , Cn), the filtering step filters the sensors (C1, C2, . . . , Cn) to keep only the sensors (C1, C2, . . . , Cn) which send signals necessary for prediction and/or detection of anomalies.

The computer infrastructure (2) can therefore comprise an interface (not shown) which selects for each sensor (C1, C2, . . . , Cn) the type of signal necessary for prediction and/or detection of anomalies and select in all the sensors (C1, C2, . . . , Cn) a certain number of sensors (C1, C2, . . . , Cn) which will be used for the filtering of said data or said signals necessary for prediction and/or detection of anomalies.

In this way, the prediction step (102) further comprises a first filtering step (106b), by the filtering algorithm (6) managed by the processor (4), of the statistical data as a function of the sensor(s) (C1, C2, . . . , Cn) having sent the signals representative of these statistical data. The first filtering step (106b) precedes the construction step (102a).

The detection step (101) comprises a second filtering step (105b), by the filtering algorithm (6) managed by the processor (4), of signals representative of the statistical data as a function of the sensor(s) (C1, C2, . . . , Cn) having sent these representative signals. The second filtering step (105b) precedes the comparison step (101a).

In a first display step (103), the values (103a) of future variations as well as the confidence intervals calculated during step (102c) for calculating the prediction step (102) are sent in the form of signals representative of these values by the processor (4) to the display means (5) to be displayed on the display means (5).

The first filtering step (106b) precedes the first aggregation step (106a). The second filtering step (105b) precedes the second aggregation step (105a).

The detection step comprises a second display step (104) in which the processor (4) of the system for aiding maintenance sends to the display means (5) at least one signal representative of an anomaly detected by the detection algorithm (9) when an anomaly has been detected by the detection algorithm (9).

The processor (4) can send to the display means (5) the signals representative of the anomalies in the form of a table of anomalies. The sent table of anomalies is, for example, the table (102e) of anomalies of those detected anomalies stored in the storage means (3) during the detection step (102).

A user (0) of the system for aiding maintenance and optimization could look at the display means to decide on actions to take for optimizing the operation of the supercomputer as a function of information displayed on the display means.

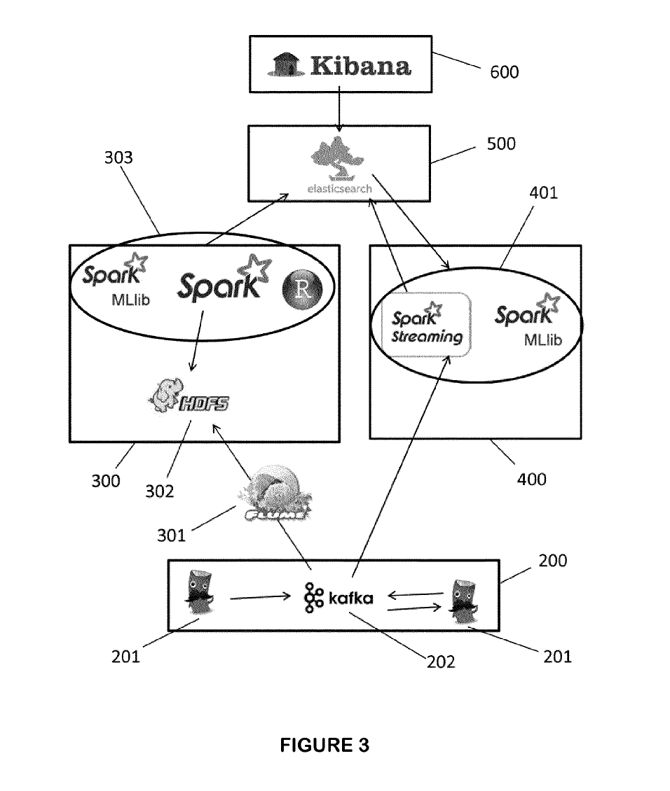

A possible architecture of the system for aiding maintenance and optimization (FIG. 3) is described hereinbelow. This is a software architecture divided into several layers to make the prediction step and the detection step at the same time.

As for the sending step by the sensor(s) (C1, C2, . . . , Cn) of signals representative of the statistical data, in a data ingestion layer (200), a tool is used for collecting, analyzing and storing logs or log files such as, for example, “LogStash” (201) serving as connector from different log emission protocols.

“Log” or “log file” means a text file which lists chronologically the executed events. The log is a file useful for understanding the provenance of an error or an anomaly.

The “LogStash” (201) tool sends data to a message-oriented tool such as “Kafka” (202) which is responsible for managing data. By nature, the “Kafka” (202) tool is a message broker which integrates a queue for scaling and absorbing a large number of data.

The “LogStash” (201) tool can also implement the filtering steps on the input data.

Once the steps for collecting and/or filtering data are performed by the “LogStash” (201) tool, said data are used for implementing the prediction step, in a heavy processing layer (300) called “batch”. A tool for collecting, aggregating and transferring large numbers of logs such as for example “Flume” (301) is used. The “Flume” (301) tool is a connector between the data-management tool “Kafka” (202) and a distributed file system such as “HDFS” (302) in which the data are saved. Once the data are saved, the construction step and the calculation step are implemented by means of a platform for distributed processing such as for example “Spark” (303).

“Distributed system”, “distributed platform” or generally distributed architecture, means architecture having resources not on the same place or on the same machine, the resources being interconnected by communication means. For example, a compute cluster or a supercomputer are distributed architectures or systems. In fact, by definition a supercomputer has a central machine and autonomous secondary stations or machines called nodes, the central machine and the nodes being connected by a communication network.

The “Spark” (303) tool uses the language R which comprises a large number of statistical tools aiding analysis of data, in this case the construction of the statistical mathematical model and calculation of predicted values and confidence intervals.

The “Spark” tool, for example, implements aggregation steps (105a, 106a).

As for the detection step, in a processing layer (400) in real time, a distributed processing platform is also used, but carrying out processing in real time. A version in real time of the “Spark” (303) tool such as for example “Spark Streaming” (401) can be used.

The results, obtained in the heavy processing layer (300) for the prediction step and the processing layer (400) in real time for the detection step, are indexed by a distributed search engine such as for example “elasticsearch” (500).

For the display step, a web interface such as “Kibana” (600) for example can be used. The “Kibana” (600) interface focuses on graphic display of results by making requests on the search engine “elasticsearch” (500).

The present description details various embodiments and configurations in reference to figures and/or technical characteristics. The skilled person will understand that the various technical characteristics of the various modes or configurations can be combined together unless explicitly stated otherwise or these technical characteristics are incompatible. Similarly, a technical characteristic of an embodiment or configuration can be isolated from the other technical characteristics of this embodiment unless explicitly stated otherwise. In the present description, many specific details are supplied by way of illustration and non-limiting, so as to precisely detail the invention. The skilled person will however understand that the invention can be carried out in the absence of one or more of these specific details or with variants. On other occasions, some aspects are not detailed so as to prevent complicating and overburdening the description and the skilled person will understand that various and varied means could be used and the invention is not limited to the sole examples described.

It must be evident for skilled persons that the present invention enables embodiments in many other specific forms without departing from the field of application of the invention as claimed. Consequently, the present embodiments must be considered by way of illustration, but can be modified in the field defined by the scope of the appended claims, and the invention must not be limited to the details given hereinabove.

1. A method for aiding maintenance and optimization of a supercomputer, the method comprising:
sending step, by at least one sensor, a signal representative of statistical data of at least one compute node of the supercomputer to a system for aiding maintenance;
predicting at regular intervals, by a prediction algorithm managed by a processor of the system for aiding maintenance, the future variations in the statistical data from the signals representative of the statistical data sent by the sensor and stored in storage of the system for aiding maintenance; and
detecting in real time, by a detection algorithm managed by the processor, anomalies of variations in the signals representative of the statistical data sent by the sensor relative to the future variations predicted in the predicting;
wherein the predicting future variations and detecting anomalies comprise at least one first and one second filtering, and respectively, of said signals representative of the statistical data consisting of selecting, as a function of said sensor having sent said signals, the signals necessary for implementing maintenance and optimization of said supercomputer.

2. The method according to claim 1, wherein the predicting comprises:
storing in the storage of the statistical data sent by the sensor in the form of signals representative of these statistical data;
constructing, by a modelling algorithm managed by the processor, a predictive mathematical model from the statistical data, the model being stored in the storage;
calculating, by a calculation algorithm managed by the processor, the future variations in the statistical data from the predictive mathematical model as well as the confidence intervals delimiting the future variations in the statistical data; and
storing in the storage the future variations and the confidence intervals.

3. The method according to claim 1, wherein the construction of the predictive mathematical model is calculated by the modelling algorithm managed by the processor from the statistical data from the signals representative of these statistical data sent by the sensor from the last two hours.

4. The method according to claim 1, wherein the predicting is implemented at regular intervals of sixty minutes.

5. The method according to claim 1, wherein the detecting comprises:
comparing, by the detection algorithm managed by the processor, the signals representative of the statistical data with the future variations and confidence intervals stored last in the storage;
storing, in the storage, in a table of anomalies, the anomalies detected by the detection algorithm, an anomaly being detected when the signals representative of the statistical data exit from the confidence intervals and/or move away from the future variations.

6. The method according to claim 1, wherein the predicting further comprises a first aggregation, during a set time interval, by an aggregation algorithm managed by the processor, of the statistical data stored in the storage, the detecting further comprising a second aggregation by the processor, during the same time interval, of the signals representative of the statistical data sent in real time by the sensor.

7. The method according to claim 1, wherein the first filtering, by a filtering algorithm managed by said processor, of the statistical data as a function of said sensor having sent said signals representative of these statistical data during the prediction step, precedes the constructing, the second filtering in the detecting, by the filtering algorithm managed by the processor, of the signals representative of the statistical data as a function of said sensor having sent these representative signals, precedes the comparing.

8. The method according to claim 1, wherein the at least one first and second filtering filter the sensors to keep only the sensors which send signals necessary for prediction and/or detection of anomalies.

9. The method according to claim 1, wherein the predicting comprises a first displaying in which the processor of the system for aiding maintenance sends signals representative of the values of the future variations as well as the confidence intervals to a display to be displayed by the display.

10. The method according to claim 1, wherein the detecting comprises a second displaying in which the processor of the system for aiding maintenance sends to the display a signal representative of an anomaly detected by the detection algorithm when an anomaly has been detected by the detection algorithm.

11. The method according to claim 1, wherein the predicting is further performed from information relating to the supercomputer, the data, stored in a storage area of the supercomputer and containing said information, being sent to the system for aiding maintenance.

12. A system for aiding maintenance and optimization of a supercomputer comprising a computer infrastructure including at least one processor and storage of the signals representative of the statistical data sent by at least one sensor located in at least one compute node of said supercomputer, said storage also comprising at least:
a prediction algorithm, whereof execution on said processor predicts, at regular intervals, future variations in the statistical data from the signals representative of statistical data from said sensors,
a detection algorithm, whereof execution on said processor detects, in real time, anomalies of variations in the signals representative of the statistical data from said sensors relative to the variations predicted by the prediction algorithm,
wherein the system also comprises at least one algorithm whereof execution on the processor filters said signals representative of the statistical data by selecting, as a function of said sensor having sent said signals representative of these statistical data, signals necessary for implementing the method according to claim 1.

13. The system according to claim 12, wherein the computer infrastructure further comprises:
a modelling algorithm stored in the storage capable of constructing a predictive mathematical model from the statistical data stored in the storage,
a calculation algorithm stored in the storage capable of calculating future variations in the statistical data from the predictive mathematical model as well as confidence intervals delimiting the future variations in the statistical data.

14. The system according to claim 12, wherein the detection algorithm is capable of comparing signals representative of the statistical data with the future variations and confidence intervals stored last in the storage.

15. The system according to claim 12, wherein the computer infrastructure comprises at least one aggregation algorithm stored in the storage capable of aggregating each minute of the statistical data stored in the storage and aggregating each minute of the signals, representative of the statistical data, sent in real time by the sensor.

16. The system according to claim 12, wherein the computer infrastructure further comprises a filtering algorithm stored in the storage capable of filtering the statistical data stored, the storage means and the signals, representative of the statistical data, as a function of the sensor having sent the signals representative of these statistical data.

17. The system according to claim 12, wherein the computer infrastructure comprises an interface which selects for each sensor the type of signal necessary for the prediction and/or detection of anomalies and selects in all the sensors a certain number of sensors which are used for the filtering of said data or said signals necessary for the prediction and/or detection of anomalies.

18. The system according to claim 12, wherein the system further comprises a display capable of displaying at least the values of the future variations as well as the confidence intervals.
